(19) United States
(12) Patent Application Publication
(10) Pub. No.: US 2011/0036426 A1
(43) Pub. Date: Feb. 17, 2011

(54) Fluid Pressure Control Device

(75) Inventor: Walter Franklin Guion, Oxnard, CA (US)

Correspondence Address: MARK DAVID FOX, 588 SUTTER STREET, SUITE 555, SAN FRANCISCO, CA, 94102, US

(73) Assignee: SP TECHNOLOGIES LC, Cheyenne, WY (US)

(21) Appl. No.: 12/855,494

(22) Filed: Aug. 12, 2010

Related U.S. Application Data
(60) Provisional application No. 61/233,160, filed on Aug. 12, 2009.

(51) Int. Cl. F15D 1/00

(52) U.S. Cl. 137/561 R

(57) ABSTRACT

The current invention is a device for controlling, or regulating, fluid pressure from a source of unregulated fluid pressure. Without being bound by theory, the invention controls output fluid pressure by balancing the pressures and/or forces placed upon a shuttle that is located in a chamber; the chamber having an inlet for fluid of an unregulated fluid pressure and an outlet for dispensing fluid with a controlled, or regulated, fluid pressure. The invention controls the fluid communication between the chamber inlet and outlet through a valve; with the valve inlet being located on or in the shuttle. As a result one unique aspect of the invention is that, unlike conventional fluid controllers and regulators, the invention does not require a diaphragm to control fluid pressures as the invention utilizes the various forces on, and resultant movements with relation to the chamber of, the shuttle to control the output fluid pressure.

### CROSS REFERENCE TO RELATED APPLICATION

This application claims the benefit for priority purposes from U.S. Provisional Application No. 61/233,160 filed Aug. 12, 2009, which is incorporated herein by reference in its entirety for all purposes.

### BACKGROUND OF THE INVENTION

The present invention is a device for controlling fluid pressure. Further, the current invention can be a device for regulating fluid pressure; that is a device that produces a fluid output with a constant fluid pressure from a source of unregulated or fluctuating fluid pressure.

### SUMMARY OF THE INVENTION

Without being bound by theory, the current invention controls fluid pressure by virtue of pressures and/or forces placed upon a shuttle that is located in a chamber. The chamber has an inlet for unregulated fluid pressure and an outlet for controlled fluid pressure, with fluid communication between the chamber inlet and outlet being controlled through a valve that has its inlet located on or in the shuttle.

As a result one unique aspect of the current invention is that, unlike most convention fluid pressure controllers and fluid pressure regulators, the current invention does not require a diaphragm to control or regulate fluid pressure. Without being bound by theory, the current invention controls or regulates the fluid pressure at the chamber outlet by utilizing the various forces placed on the shuttle, with these forces producing movement of the shuttle with relation to the chamber. This movement of the shuttle with relation to the chamber consequently results in fluid movement between the chamber inlet and outlet via the valve inlet that is on or in the shuttle.

### BRIEF DESCRIPTION OF THE DRAWINGS

FIG. 1 is a cross sectional view of a shuttle and related internal components used in an embodiment of the current invention.

FIG. 2 is a cross sectional view of the chamber, shuttle and related internal components used in an embodiment of the current invention.

FIG. 3 is an external view of a shuttle showing dimensions used in an embodiment of the current invention.

FIG. 4a is a Schrader valve showing dimensions used in an embodiment of the current invention.

FIG. 4b is a cross-sectional view of a shuttle used to secure the Schrader valve in FIG. 4a as used in an embodiment of the current invention.

FIG. 5 is a cross-sectional view of a chamber showing dimensions as used in an embodiment of the current invention.

### DETAILED DESCRIPTION OF THE PREFERRED EMBODIMENT

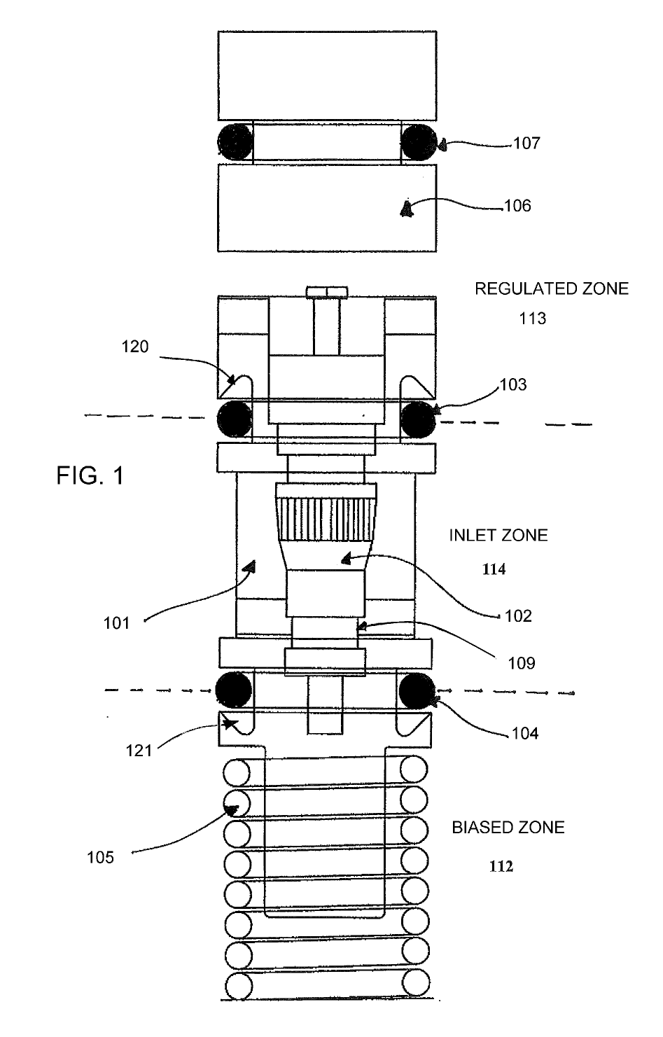

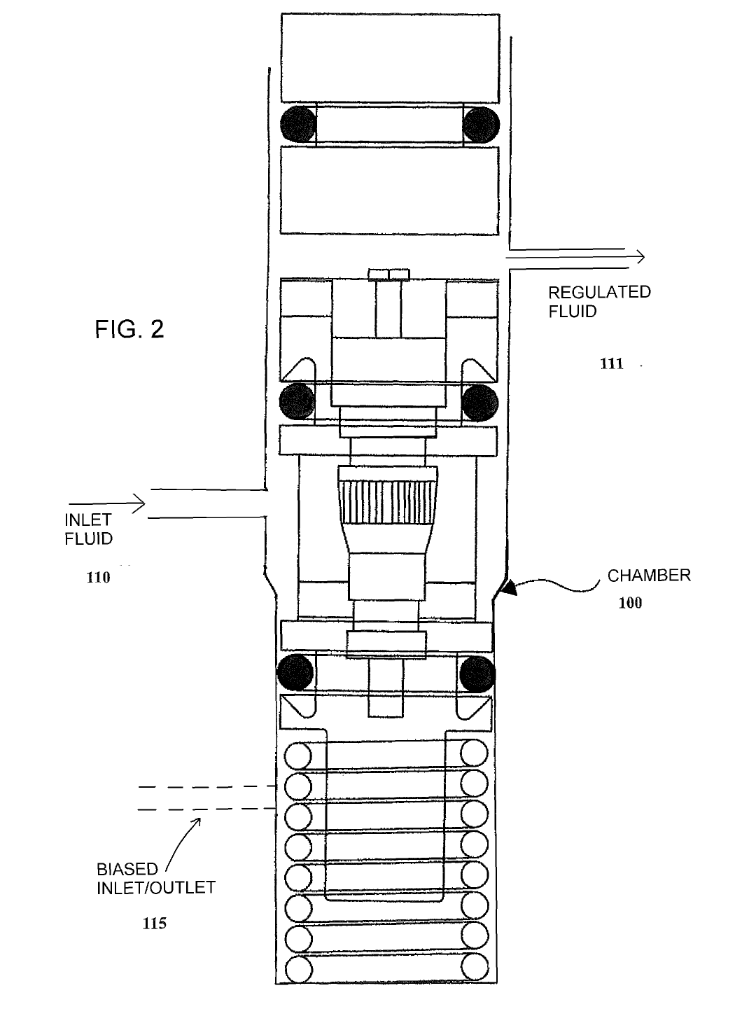

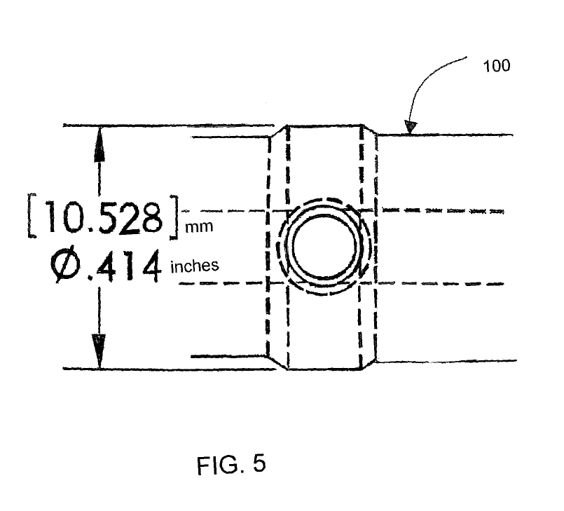

As shown in FIG. 2, an embodiment of the current invention uses a cylindrical shaped shuttle 102 that is located in a chamber 100 which has an inlet 110 for introducing fluid and an outlet 111 for discharging fluid. As shown in FIGS. 1 and 2, the shuttle secures two o-rings 103, 104 in holding grooves 120, 121 at the opposing distal ends of the shuttle 101. The two o-rings 103, 104 provide moveable seals that create three fluidly isolated regions or zones between the shuttle 101 and chamber 100: the biased or control zone 112; the outlet or regulated zone 113; and the inlet or unregulated zone 114. Further, provided the relative fluid isolations between the zones are adequately maintained in operation, the chamber 100 can have various cylindrical or conical-type shaped configurations, as shown in FIGS. 2 and 5 for example.

The embodiment of the current invention shown in FIG. 1 further provides a valve 102 with the valve inlet 109 located in the shuttle 101. The valve 102 provides fluid communication between the inlet zone 114 and outlet zone 113 via the valve inlet 109. Further as shown in FIG. 1, in the outlet zone 113 there is an optional pressure adjuster 106 sealed against the chamber walls by a third o-ring 107. Further as shown in FIG. 2, in the biased or control zone 112 there is an optional biased inlet/outlet 115. This optional biased inlet/outlet 115 can be attached to additional source of fluid or hydraulic pressure, or can be used to negate the effects of any unwanted fluid pressure in the control zone; for example the optional biased inlet/outlet 115 can be used to vent the control zone to atmospheric pressure.

Without being bound by theory, the current invention embodied in FIGS. 1 and 2 controls fluid pressure by virtue of the forces on the distal ends of the shuttle 101. In the embodiment of the current invention in FIGS. 1 and 2, any force at a distal end of the shuttle 101 will produce displacement or movement of the shuttle 101 with relation to the chamber 100. In the embodiment in FIGS. 1 and 2, one type of force placed on the shuttle at the distal end in the control zone 112 can be a physical resistance force provided by a spring 105. In a further embodiment of the current invention the force on the shuttle at the distal end in the control zone 112 could be provided by other mechanisms, such as hydraulic fluid pressure force, or by a more sophisticated physical system such as a plurality of springs of different resistance which can produce more sensitive and/or a wider range of physical forces than a single spring.

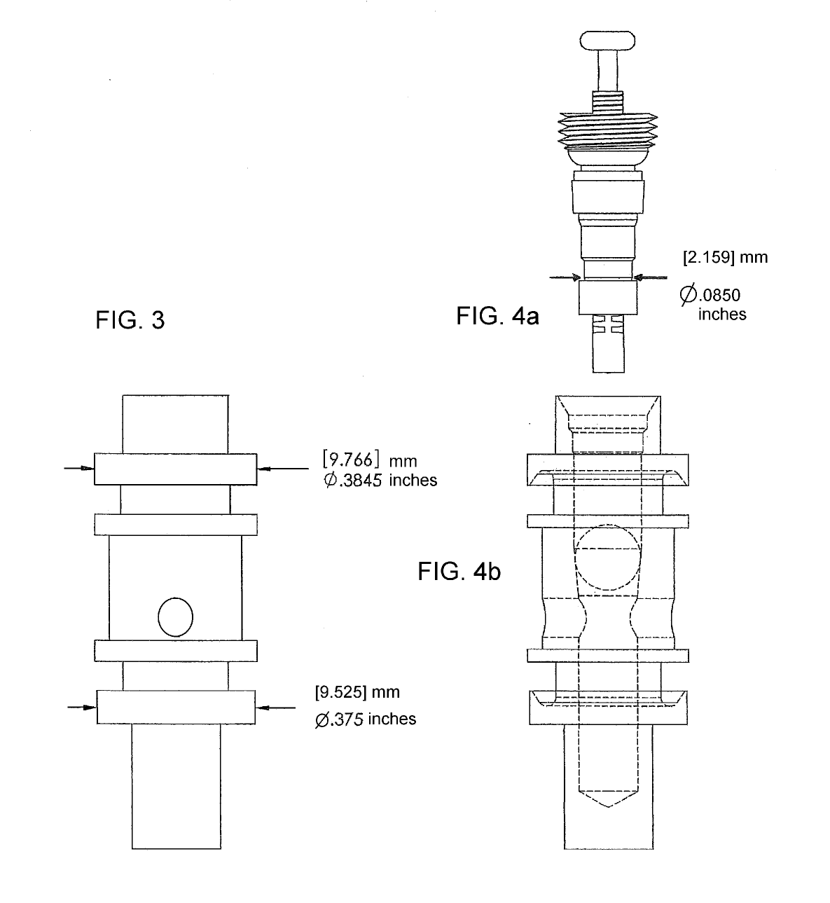

Further as shown in generally in FIGS. 1 and 2, and in more detail in FIG. 3, in an embodiments of the current invention the relative surface area of shuttle 101 that is exposed to the different forces at the different zones is also an important aspect of the current invention. As shown in FIGS. 1 and 3 the shuttle 101 has a larger surface area at the distal end in the outlet zone 113 than the shuttle's surface area at the distal end in the control zone 112. This difference in diameter between the control zone 112 and outlet zone 113 for the shuttle is also shown in FIG. 2, which also shows a larger diameter for the chamber in the outlet zone 113 than the diameter for the chamber in the control zone 112.

The relationship in the relative size of the surface area of the distal ends of the shuttle 101, as shown in an embodiment of the current invention in FIGS. 1 to 4 inclusive, is directly related to the size of the valve inlet 109 on the shuttle 101.

In a preferred embodiment of the current invention, as shown in an embodiment of the current invention in FIGS. 1 to 4 inclusive, the surface area of the shuttle 101 subject to forces at the outlet zone 113 less, or minus, the surface area of the valve inlet 109 is 0.5 to 2 times the surface area of the shuttle 101 subject to the pressure force at the control zone 112.

In an embodiment of the current invention, the invention can also provide pressure regulating capabilities with the surface area of the shuttle 101 subject to forces at the outlet zone 113 less, or minus, the area of the valve inlet 109 compared to the surface area of the shuttle 101 that is subject to the forces in the control zone 112 being good at a ratio of 0.75 to 1.5, better at a ratio of 0.9 to 1.1, and the best at a ratio of 1.

As shown in FIGS. 3 to 5 inclusive, another example of an embodiment of the current invention uses a high-pressure Schrader valve, such as a Bridgeport Core #9914 Schrader valve, as the valve 101, with a valve inlet 109 diameter of 0.0850 inches (2.159 millimeters), 010 O-rings for both o-rings 103 and 104, shuttle 101 with diameters at the respective distal ends of 0.3845 inches (9.766 millimeters) at the outlet zone 113 and 0.375 inches (9.525 millimeters) at the control zone 112 with a Helix Spiral: Profile Dia. 0.0044×Path Dia. 0.300×Height: 0321 spring 105 and an optional biased inlet/outlet 115 to vent the control zone 112 to atmospheric pressure.

Further, using the following below for the tables and formulae:
R=desired ratio between the shuttle at the output zone and the valve inlet to the shuttle at the control zone
Ø_{Vi}=diameter of valve inlet 109
Ø_{SO}=diameter of shuttle 101 at the outlet zone 112
Ø_{SC}=diameter of shuttle 101 at the control zone 113
   the following table shows typical diameters for the embodiment of the current invention shown in FIGS. 3 and 4 where R=1.0:

TABLE 1
Typical diameters (millimeters) for embodiment in FIGS. 3 and 4
R = 1.0

| Ø_{Vi} | Ø_{SO} | Ø_{SC} |
|---|---|---|
| 2.1590 | 9.5250 | 9.7663 |
| 2.2860 | 9.5250 | 9.7942 |
| 2.3114 | 9.5250 | 9.8019 |
| 2.3368 | 9.5250 | 9.8069 |
| 6.3500 | 12.7000 | 14.1986 |

Further, and more generally, for the embodiment of the current invention as shown in FIGS. 1 and 2, the diameters of the valve inlet and the shuttle at the control zone and outlet zone can be based on the following formula:

$${( \frac{{∅}_{Vi}}{2} )}^{2} = {R ( \frac{{∅}_{SO}}{2} )}^{2} - {( \frac{{∅}_{SC}}{2} )}^{2}$$

In addition, as shown in FIGS. 1, 2 and 4b at least one of the sidewalls of the holding grooves 120, 121 in the shuttle is not perpendicular to the surface of the shuttle. Without being bound by theory, in the embodiment of the invention shown in FIGS. 1, 2 and 4b it has been found that an angled sidewall to a holding groove as shown provides smoother movement of the shuttle 101 in the chamber 100 in operation, and quicker and smoother fluid pressure control properties while still maintaining adequate fluid isolation in the relevant zones isolated by the o-ring secured by the holding groove.

Further it should be noted that there is no limitation on the physical size of the shuttle 101, chamber 100, or any other components or elements described herein and that the examples of embodiments described herein place no limitation on the physical dimensions of the shuttle 101, chamber 100, or any other components or elements,

Although the foregoing description of certain preferred embodiments has shown, described and pointed out the fundamental novel features of the invention, it will be understood that various omissions, substitutions, and changes in the form of the detail of the invention as illustrated as well as the uses thereof, may be made by those skilled in the art, without departing from the spirit of the invention. Consequently, the scope of the invention should not be limited to the foregoing discussions.

What is claimed is:

1. A fluid pressure controller comprising
a chamber with an inlet for introducing gaseous or fluid material and an outlet for discharging gaseous or fluid material;
a valve providing fluid communication between the inlet and outlet;
a shuttle inside the chamber, the valve inlet being located on or in the shuttle;
a first seal between the chamber and shuttle, the first seal preventing fluid communication between the inlet and outlet except through the valve inlet, the first seal further defining an outlet zone in the chamber;
a second seal between the chamber and shuttle defining a control zone in the chamber, the second seal preventing fluid communication between the inlet and the control zone;
a control pressure being applied to the shuttle in the control zone; and
the surface area of the shuttle subject to the fluid pressure at the outlet zone minus the surface area of the valve inlet being equal to 0.5 to 2 times the surface area of the shuttle subject to the control pressure.

2. A fluid pressure controller as in claim 1 wherein the surface area of the shuttle subject to the fluid pressure at the outlet zone minus the surface area of the valve inlet being equal to 0.75 to 1.5 times the surface area of the shuttle subject to the control pressure.

3. A fluid pressure controller as in claim 1 wherein the surface area of the shuttle subject to the fluid pressure at the outlet zone minus the surface area of the valve inlet being equal to 0.9 to 1.1 times the surface area of the shuttle subject to the control pressure.

4. A fluid pressure controller as in claim 1 wherein the surface area of the shuttle subject to the fluid pressure at the outlet zone minus the surface area of the valve inlet is equal to the surface area of the shuttle subject to the control pressure.

5. A fluid pressure controller as in claim 1 wherein the fluid pressure at the outlet zone is further adjusted by a moveable pressure adjuster.

6. A fluid pressure controller as in claim 1 wherein the shuttle is cylindrical in shape but has different diameters at its distal ends, the distal end with the larger diameter defining the surface area of the shuttle subject to the fluid pressure at the outlet zone, the distal end with the smaller diameter defining the surface area of the shuttle subject to the control pressure.

7. A fluid pressure controller as in claim 6 wherein the opening for the valve inlet is circular with diameter of the opening for the valve defining the surface area of the opening for the valve.

8. A fluid pressure controller as in claim 1 wherein the control pressure is made by a spring.

9. A fluid pressure controller as in claim 8 wherein the control pressure is made by a plurality of springs with at least one spring having a different compression resistance than the other springs.

10. A fluid pressure controller as in claim 1 wherein at least one seal is an o-ring.

11. A fluid pressure controller as in claim 10 wherein the o-ring is secured in a groove in the shuttle.

12. A fluid pressure controller as in claim 11 wherein the base of groove in the shuttle securing the o-ring is wider than the top of the groove.

13. A fluid pressure controller as in claim 12 wherein one of the sidewalls of the groove in the shuttle securing the o-ring is not perpendicular to the surface of the shuttle.
